(19) United States
(12) Patent Application Publication
(10) Pub. No.: US 2008/0060047 A1
(43) Pub. Date: Mar. 6, 2008

(54) Media Device

(75) Inventors: David Holliday, Herts (GB); Ian Trimnell, Surrey (GB); Ben Freeman, Henley on Thames (GB); Robin Crossley, Berks (GB); Nicholas James, Surrey (GB)

Correspondence Address: ROTHWELL, FIGG, ERNST & MANBECK, P.C., 1425 K STREET, N.W., SUITE 800, WASHINGTON, DC, 20005, US

(73) Assignee: British Sky Broadcasting Limited Grant Way, Middlesex (GB)

(21) Appl. No.: 10/587,839

(22) PCT Filed: Jan. 28, 2005
(86) PCT No.: PCT/GB05/00304

§ 371 Date: Nov. 9, 2007

(30) Foreign Application Priority Data
Jan. 28, 2004 (GB) 0401830.5

(51) Int. Cl. H04N 7/16

(52) U.S. Cl. 725/139

(57) ABSTRACT

A receiver (3) for television signals has a primary video output (22a) connected to a primary TV (2a) and a secondary video output (22b) connected to a secondary TV (2b) at a remote location (42b). The receiver (3) can be controlled by an infrared remote control (28) either directly or from the remote location (42b) via a remote control extender (40). The primary TV (2a) may be a widescreen TV with a 16:9 picture format, while the secondary TV (2b) has a 4:3 picture format. The receiver (3) can output video signals suitable for either format, but must apply the same format to both the primary and secondary video outputs (22a, 22b). The receiver (3) detects whether control signals are arriving directly or via the remote control extender, and automatically selects the correct format. In another embodiment, a wireless audio base station (55) is connected to the receiver (3) for relaying audio signals and programme data to a wireless audio receiver (60). The programme data is encoded as characters for display by the wireless audio receiver (60). The wireless audio receiver (60) also relays user control signals back to the base station (55) for controlling the output of the receiver (3). This embodiment allows convenient listening to radio stations and display of programme information.

### FIELD OF THE INVENTION

One aspect of this invention relates to a media device, particularly with multiple media outputs. Another aspect relates to a broadcast receiver with a local wireless relay.

### BACKGROUND OF THE INVENTION

Conventional terrestrial television sets normally include receiver circuitry integrated with a display, such as a cathode ray tube (CRT), integrated in the same box. Many households have multiple television sets in different rooms, such as a main television set in the living room and smaller television sets in bedrooms or the kitchen. Each of these sets is connected to a separate ultra high frequency (UHF) socket, all of which can be connected to the same terrestrial TV aerial or to different aerials.

Satellite and cable receivers are usually provided in a set-top box (STB) separate from, but connectable to a television set. The STB decodes audio and video signals from a satellite or cable broadcast and outputs them to the television set through a SCART (Syndicat Français des Constructeurs d'Appareils Radio et Télévision, the body which standardised the format) or RF connector. This allows STB's to be used with existing terrestrial television sets.

If satellite or cable television is to be available in more than one room in a household, separate STB's can be provided in each room at additional cost. However, STB's may store records of programmes selected for future viewing, and/or recordings of programmes previously broadcast, and users may want to access the same set of programmes regardless of where they are in the household. These considerations suggest that one STB should provide audio and video signals to multiple devices in different rooms.

Examples of satellite receiver STBs provided by the applicant, British Sky Broadcasting Ltd., are the Sky® Digibox® and Sky⁺® set top boxes. Both of these have a second RF output to allow connection to a secondary display. The second RF output can be connected to a display in another room, and IR control signals can be relayed from the other room to the STB by a relay system. One such system is the Global® tvLINK® system available from Global Communication (UK) Ltd., Althorne, Essex, UK.

However, such a relay system does not solve problems arising from differences between a primary display and the secondary display to which the relay system is connected. For example, the main display may be a widescreen display with an aspect ratio of 16:9 (horizontal:vertical), while the secondary display may be a display with a more conventional aspect ratio of 4:3. The user may select a picture format mode on the STB corresponding to the aspect ratio of the main display and/or user preferences. For example, the user may select a 4:3 mode, in which case video signals in 4:3 format will be displayed as normal, while video signals in 16:9 format will be converted by the STB into a 4:3 signal. In a 4:3 letterbox mode, the 16:9 format signals are converted to 4:3 format by including blank bands above and below the picture so that the picture retains the 16:9 aspect ratio. In a 4:3 non-letterbox mode, the 16:9 format picture is cropped at both sides to a 4:3 aspect ratio. In a 16:9 mode, video signals broadcast in a 16:9 format are displayed as normal, while video signals broadcast in a 4:3 format are distorted horizontally to produce a picture with a 16:9 aspect ratio. Video signals broadcast as a 16:9 aspect ratio picture in a 4:3 letterbox format are converted into a 16:9 format signal by discarding the bands above and below the picture.

Only one picture format mode can be selected at any one time, for both the primary and secondary video outputs. Hence, a mode selected to be suitable for the main display will not be suitable for the secondary display if one is a widescreen display and the other is not. For example, a 16:9 mode may be set for compatibility with the main, widescreen display. However, a user wants to watch a programme on the secondary display, which has a 4:3 aspect ratio. The user must manually change the mode by selecting a system setup menu and selecting and changing the mode, before the programme can be viewed in the correct format. This is inconvenient for the user, who would normally never have to change the format if only the primary TV 2a is used, and is an obstacle to user acceptance of the secondary display feature.

Another problem relates to listening to radio channels over a television receiver. Satellite and cable television broadcast services include, in addition to television channels which carry both video and audio streams, radio channels which carry audio streams but no video stream. When the television receiver is tuned to a radio channel, the audio signal is output to a television display and can be heard through a loudspeaker integrated with the television display, or connected directly to the television display, for example by audio connectors. The STB may output a video signal showing a static picture, indicating for example the radio station to which the STB is tuned. The STB can also display an electronic program guide (EPG) showing a schedule of programmes, including radio programmes, at different times and on different channels.

However, radio channels received in this way can only be listened to in the vicinity of the STB, unlike conventional terrestrial radio channels which can be received by a portable radio and listened to wherever the user desires.

An audio sender can be connected to an audio output of the STB to relay the audio signal of the received channel to a receiver at a secondary location. Alternatively, a combined audio/video sender may be used to relay both the video and the audio signal to a display at the secondary location. Some video senders include a remote control extender which detects IR signals from a remote control at the secondary location, converts them to RF signals and relays them back to the primary location for input to the STB. This allows control of the STB from the secondary location in a similar way to the tvLINK system described above, but using a wireless connection.

Hence, users wanting greater mobility when listening to radio channels and wishing to change channel without returning to the STB could use a combined audio/video sender. If the receiver part of the sender is connected to a video display, then information about the station could be viewed while listening to the radio, and the EPG may be viewed to see what other programmes are being or will be broadcast. However, the addition of the video display reduces the portability of the device.

### STATEMENT OF THE INVENTION

According to one aspect of the present invention, there is provided a video signal receiver controllable by control signals and having first and second video outputs, wherein a video display mode can be selectively set for both the first and second video outputs, the receiver being able to detect whether the control signals are received from an input associated with the first video output or the second video output, and to select a video display mode suitable for the video output with which the control signals were associated.

According to another aspect of the present invention, there is provided a first receiver for receiving a broadcast signal including an audio channel and prograrme data, the receiver including means for retransmitting the audio channel and the programme data to a second receiver, wherein the programme data is not retransmitted as an image signal.

### BRIEF DESCRIPTION OF THE DRAWINGS

Specific embodiments of the present invention will now be described with reference to the accompanying drawings, in which:

FIG. 1 is a block diagram of the functional components of a satellite broadcast receiver according to the state of the art;

FIG. 2 is a diagram of the external input and output connectors to the satellite broadcast receiver;

FIG. 3 is a diagram showing an arrangement of the receiver in a first embodiment of the invention;

FIG. 4 is a diagram of a remote control extender for use in the arrangement of FIG. 3;

FIG. 5 is a schematic diagram of a wireless version of the arrangement shown in FIG. 3;

FIG. 6 is a flowchart of the operation of a computer program executed by the receiver;

FIGS. 7 to 9 are screenshots showing the selection of a picture format;

FIG. 10 is a diagram showing an arrangement of the receiver in a second embodiment of the invention;

FIG. 11 is a diagram showing the connections between the receiver and a wireless audio base station; and

FIGS. 12 and 13 are views of a wireless audio receiver in the second embodiment.

### DETAILED DESCRIPTION OF EMBODIMENTS OF THE INVENTION

### Receiver Components

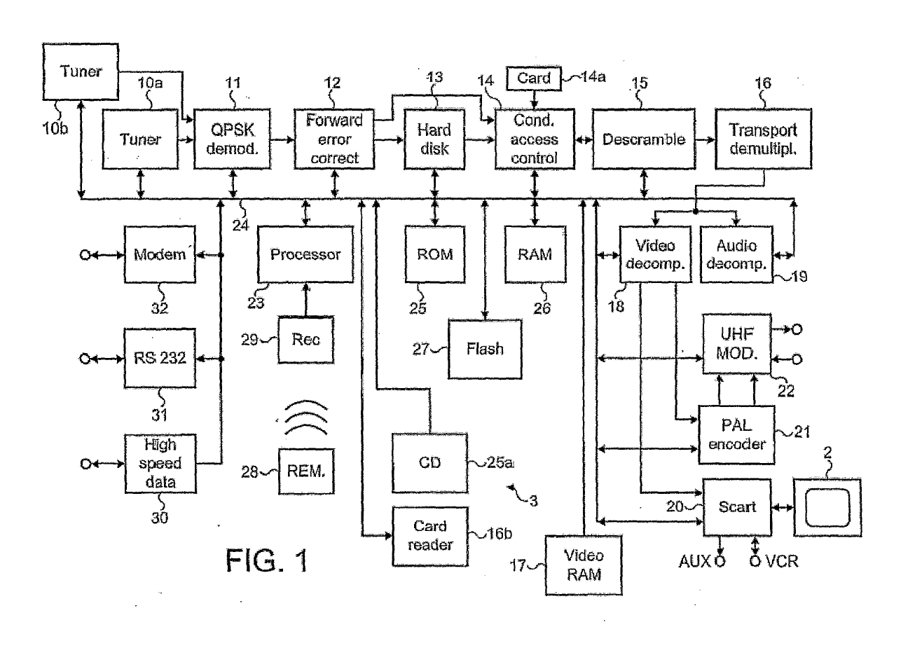

FIG. 1 of the accompanying drawings shows a satellite broadcast receiver 3 for receiving television signals from a satellite television broadcast network. In this example, received signals are input to first and second tuners 10a and 10b but any plural number of tuners may be used in the receiver 3. The tuners 10a and 10b are tuneable into the same or different channels of the satellite television broadcast network for simultaneous reception of the same or different television programmes. Signals from the first and second tuners 10a and 10b are passed to a Quadrature Phase Shift Key (QPSK) demodulator 11. Demodulated signals are error-corrected by way of a forward error corrector circuit 12. The receiver 3 has a hard disk 13 which receives from the forward error corrector circuit 12 compressed video and audio data representing received television programmes for recording and subsequent playback, as described in greater detail below.

The received signals comprise digitally encoded data. In this example, the data is compressed using the Digital Video Broadcast/Moving Pictures Expert Group 2 (DVB/MPEG 2) standard which permits both programme data and additional data (for example interactive service data) to be transmitted in a single channel. DVB/MPEG 2 enables high compression ratios to be achieved. The hard disk 13 receives and stores compressed data. The data is decompressed only after retrieval from the hard disk 13.

Satellite (and indeed cable) programmes are usually scrambled to prevent unauthorised access by non-authorised subscribers. The receiver 3 therefore has a conditional access control circuit 14 which co-operates with a smart card 14a to determine whether the viewer has subscribed to a particular channel and is therefore authorised to access the channel. Parental control over channel access is also provided, at least in part, by the access control circuit 14. The receiver 3 further comprises a descrambling circuit 15 which is controlled by the access control circuit 14 to enable the descrambling of the signal by authorised subscribers.

Descrambled data is supplied to a transport/demultiplexer 16 which separates the data into video data, audio data, user services data, programme scheduling data, etc. for distribution to various locations within the receiver 3. The receiver 3 also comprises a video decompression and processing circuit 18 utilizing a dedicated video Random Access Memory (RAM) 17, and an audio decompression and processing circuit 19, operating according to the MPEG 2 standard, for example. The video and audio decompression and processing circuits 18 and 19 receive demultiplexed signals directly from the transport/demultiplexer 16, or from the hard disk 13. Decompressed video signals are input to a SCART interface 20 for direct input to a television set (TV) 2 and to a Phase Alternation Line (PAL) encoder 21 where they are encoded into the PAL format for modulation by a Ultra High Frequency (UHF) modulator 22 for output to the UTHF input of the TV 2 if so desired.

The receiver 3 is controlled by a processor 23 which communicates with the various units of the receiver via a bus 24. The processor 23 has associated with it Read Only Memory (ROM) 25 (optionally including a Compact Disc—Read Only Memory (CD-ROM) drive 25a), Random Access Memory (RAM 26) and a flash (non-volatile and writable) memory 27.

The processor 23 controls operation of the receiver 3 by tuning the tuners 10a and 10b to receive signals for the desired channels by controlling the demultiplexing, descrambling and decompression so that the desired programme and/or interactive service data is displayed on the screen of the TV 2, and by controlling the hard disk 13 to record desired television programmes or to play back previously recorded television programmes. Viewer selection of desired programmes and customer services is controlled by viewer manipulation of a remote control unit 28, which in response to such viewer manipulation transmits control signals to a receiver 29 for input to the processor 23. The remote control unit 28 also allows the viewer to control of the operation of the hard disk 13 to record television programmes, to play back recorded television programmes and to program the recording of television programmes, etc.

The receiver 3 further comprises a high-speed data interface 30 and a Recommended Standard 232 (RS232) interface 31 providing a serial link. The high-speed data interface 30 and the RS232 interface 31 may be connected to a Personal Computer (PC) and/or a games console and/or other digital equipment (not shown). The high speed data interface 30 enables the receiver 3 to be connected to other devices (not shown), for example to enable reception of services transmitted via other media such as broadband cable, external storage media or digital terrestrial broadcast. The receiver 3 further comprises a modem interface 32 for connecting a telephone network.

Operation of the receiver 3 is controlled by software that makes the processor 23 responsive to control signals from the remote control unit 28, additional data in the received signals and/or data stored in the memory units 25 to 27. Interaction between hardware and software in the receiver 3 is described in detail in our international patent application published as WO 01/11865. Operation of the receiver 3 in receiving and decoding data representing television programmes and data defining scheduling and other information related to the programmes is described in detail in our international patent application published as WO 96/37996. Operation of the receiver 3 in providing interactive services is described in our international patent application published as WO 97/23997.

Within the Digital Video Broadcasting (DVB) standard for digital television broadcast there exists a standard for the transmission of schedule information such that it can be decoded and presented correctly to subscribers in the form of an Electronic Programme Guide (EPG). This DVB standard is known generally as the SI standard and can be found in the specification: ETS 300 468, ETSI Digital Broadcasting Systems for Television, Sound and Data Services; Specification for Service Information (SI) in Digital Video Broadcasting (DVB) Systems 2nd edition. Guidelines for using the specification are given in ETSI ETR 211-DVB SI Guidelines. The receiver 3 is designed to support the SI specification.

In addition to operating data for use in controlling access to channels, additional data in a channel can include brief programme schedule data representative of so-called event information tables (EITs) defining the scheduling of programmes in each channel. The programme schedule data is used by the receiver 3 to control the operation of the hard disk 13. When the receiver 3 is programmed to record a selected television programme, the receiver 3 operates the hard disk 13 to start and to stop the recording in accordance with the programme schedule data which comprises the start and the end time of the selected television programme. Since the programme schedule data is updated regularly, the recording is started and stopped in accordance with the updated programme schedule, thus guaranteeing that a selected television programme is actually recorded even in case of a change of programme schedule, because such change is reflected in the programme schedule data in each channel.

The programme schedule data may be stored in the RAM 26 and, once stored, the scheduling information is available effectively instantaneously for controlling the operation of the hard disk 13. As discussed above, the programme schedule data is transmitted regularly so that the receiver 3 will be updated substantially continuously. The information is brief to enable each channel to carry the progranne schedule data without excessive overheads in terms of bandwidth requirements in each channel and memory requirements in the receiver.

In addition, a dedicated EPG channel transmits more detailed programme scheduling information. The information transmitted via this dedicated channel is updated more frequently and covers a longer period of time (e.g. one week). As a consequence, an up-to-date television programme schedule of a complete week will always be available. As explained in greater detail below, the receiver 3 is arranged to display the programme scheduling information on the TV 2. Also, a viewer can interact with the receiver 3 to program recordings of television programmes, view a desired part of the available programme schedule, etc., on the basis of the information received via the dedicated EPG channel.

Accordingly, while the programme schedule data in each channel is used by the receiver 3 to operate the hard disk 13 to record a selected television programme in a selected channel at the correct up-to-date time, the programme scheduling information in the dedicated EPG channel is used to display the programme schedule for several of the channels over a predetermined period of time (which in turn is used for programming the receiver 3 as described below).

Since the tuners 10a and 10b can be tuned to receive different channels, it is possible for a first television progranme in one channel to be displayed on a TV and recorded on the hard disk 13, while at the same time a second television programme in another channel is also recorded on the hard disk 13.

The hard disk 13 of the receiver 3 is similar to conventional hard disks used in computer systems for storing large amounts of data. The hard disk 13 has a capacity of many gigabytes (e.g. 40 gigabytes) and receives video and audio data for storage in the compressed form in which it is received, for example, in accordance with the DVB/MPEG 2 standards as discussed above. This allows for the storage of several hours of television programmes (e.g. 20+ hours) on the hard disk 13. The hard disk 13 comprises two storage areas, one for the storage of television programme data, and the other for storing “metadata” which is used to control the hard disk 13, as discussed in greater detail in our earlier patent publications mentioned above. The processor 23 controls the operation of the hard disk 13. More-specifically, the processor 23 controls the recording and playback of television programmes to and from the hard disk 13. Other processors (not shown) can be used to control the hard disk 13 as appropriate, but the control is described in this document with reference to only processor 23 to facilitate understanding.

### Receiver Interfaces

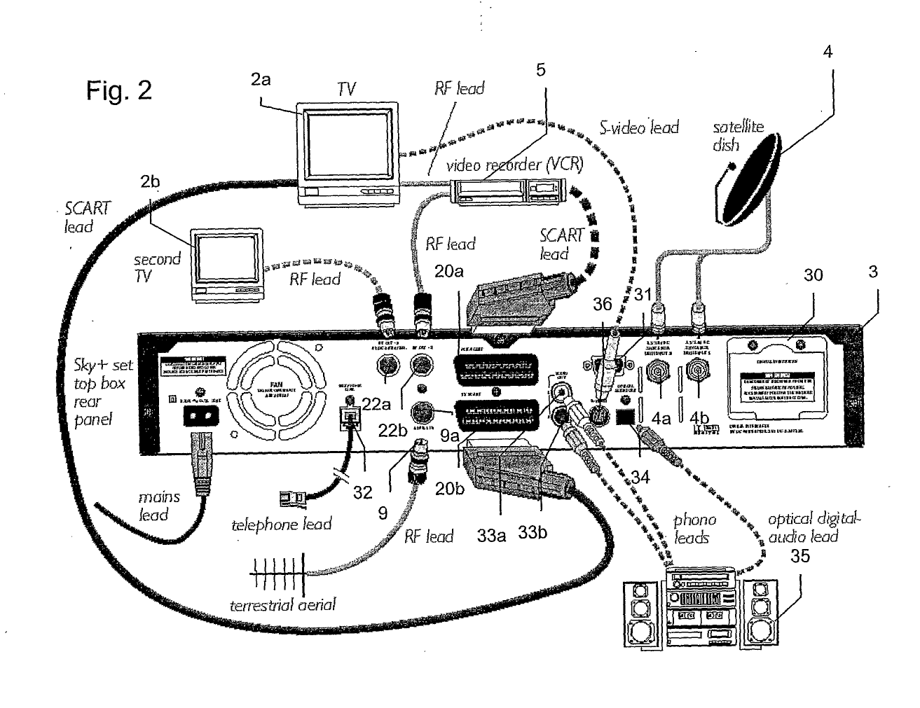

FIG. 2 shows in more detail the interfaces to the receiver 3, in this case a Sky⁺® set top box, further details of which are described in the ‘Sky⁺User's Guide’, available on the Internet on 22 Jan. 2004 at the uniform resource locator (URL):

http ://www1.sky.com/products/skyplus/Sky+PVR1.pdf

the contents of which are incorporated herein by reference.

To avoid repetition, where the same references are used in FIG. 1 and FIG. 2, the references in FIG. 2 denote the external interface of the component shown in FIG. 1.

A satellite dish 4 receives signals from the satellite television broadcast network and provides these to first and second satellite dish inputs 4a, 4b. Terrestrial television broadcast signals are received by terrestrial aerial 9 and provided to a terrestrial aerial input 9a. The UHF modulator 22 provides a primary RF interface 22a for connection to a primary TV 2a, optionally as in this case via an external video recorder 5, and a secondary RF interface 22b for connection to a secondary TV 2b. The SCART interface 20 includes a video recorder SCART socket 20a and a TV SCART socket 20b. A Separate Video (S-Video) connector 36 provides an alternative output to the primary TV 2a, if this has an S-Video input. Left and right channel audio outputs 33a, 33b, and optical digital audio output 34, for connection to external audio reproduction equipment 35, output the audio signals from the channel to which the receiver 3 is tuned.

### FIRST EMBODIMENT

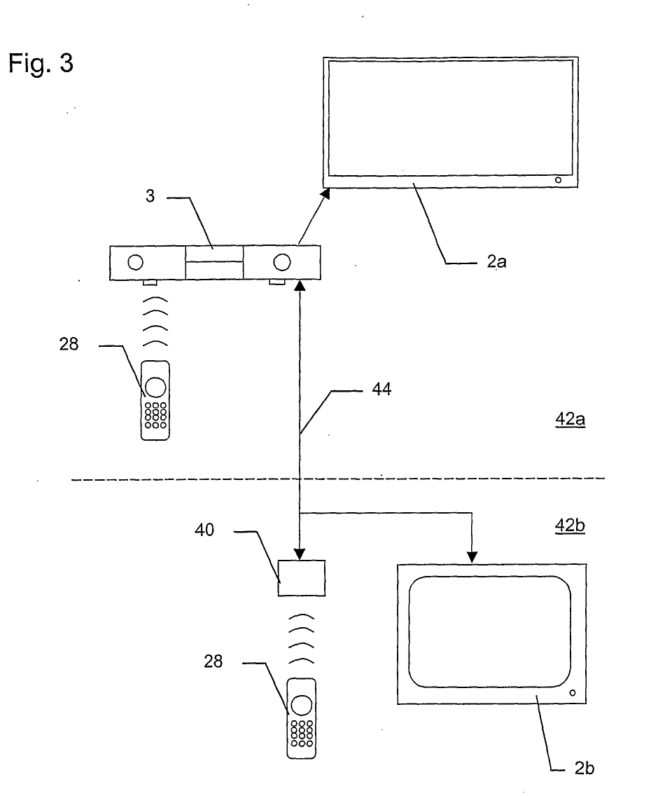

An arrangement of the receiver 3 in a first embodiment of the invention is shown in FIG. 3. The receiver 3 and primary TV 2a are at a first location 42a, together with a remote 28 actuable by a user to send control signals to the receiver 3 via an IR link. A secondary location 42b is separated from the first location 42a such that the receiver 3 at the primary location 42a cannot reliably receive control signals from the remote 28 at a secondary location. There may not be an unobstructed line of sight between the secondary location 42b and the primary location 42a, or the secondary location 42b may be too distant from the primary location 42a for the control signals to be received.

A secondary TV 2b is at the secondary location 42b and is connected to the receiver 3 through the secondary RF interface 22b by means of a connector 44. The connector 44 may be a coaxial cable, or a wireless audio/video sender. A remote control extender 40 receives the IR control signals from the remote 28 and relays them to the receiver. The remote 28 can be carried between the primary location 42a and the secondary location 42b, or different remotes could be used at each location.

The arrangement as described thus far is known per se, and may use a known wired extension system, such as the tvLINK® system, or a wireless extension system such as the video sender with remote control extender as described above.

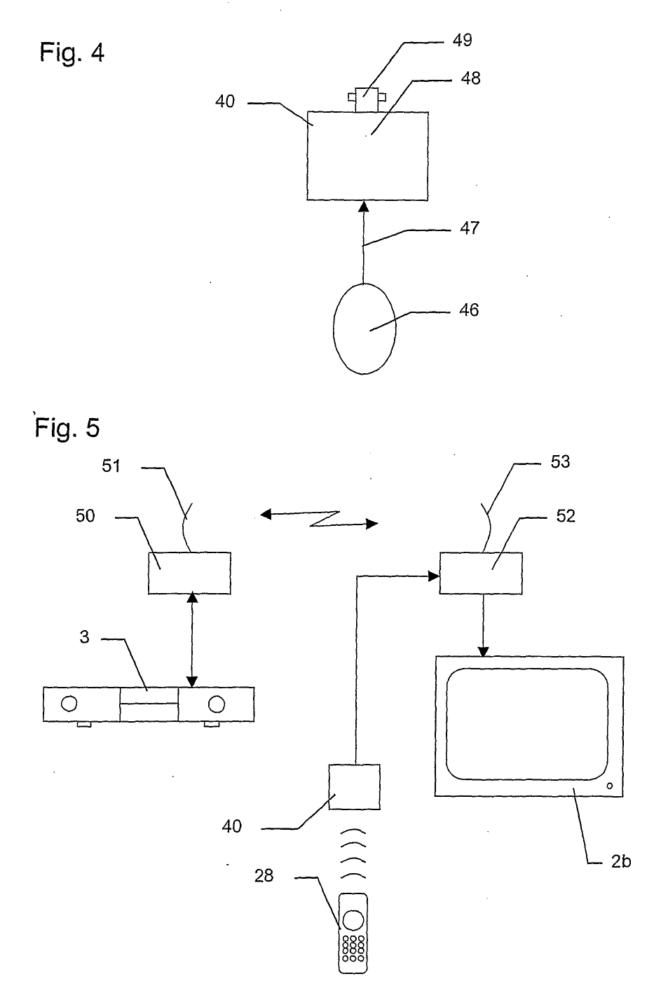

In a wired extension system, the remote control extender 40 receives IR signals from the remote 28, and converts them to modulated electrical signals in the connector 44. The coaxial cable which carries UHF signals from the receiver 3 also carries the modulated electrical signals from the remote control extender 40 to the receiver. A schematic diagram of this type of remote control extender 40 is shown in FIG. 4. An IR receiver 46 receives IR signals from the remote 28 and converts them to electrical signals which are input to a modulator 48. The modulator 48 modulates the signals and outputs them on a UHF cable connector 49 for a coaxial cable. The IR receiver 46 is connected to the modulator 48 by a cable 47 to allow convenient positioning of the IR receiver 46.

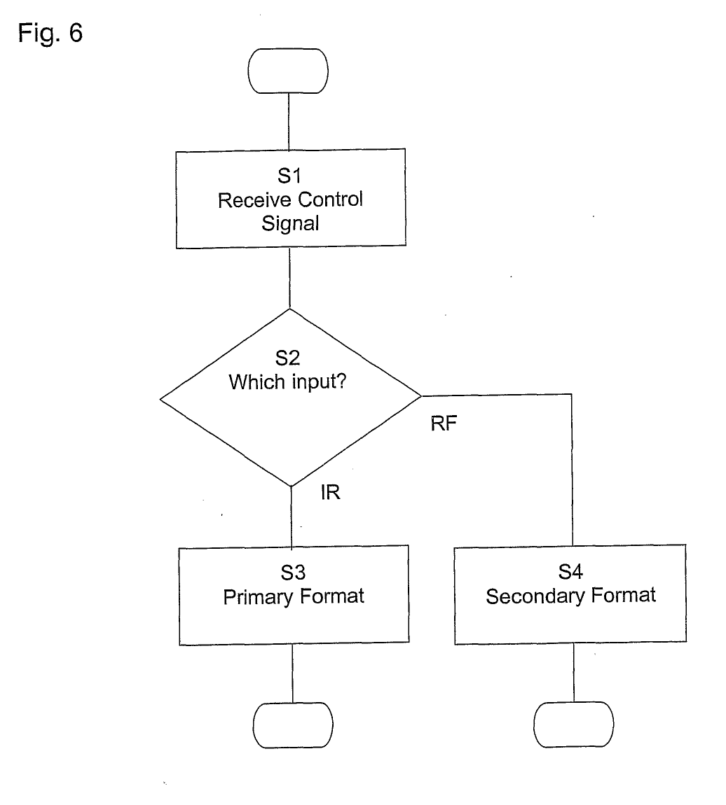

In a wireless extension system, audio and video signals output by the receiver 3 are transmitted in a frequency channel which does not interfere with terrestrial radio and TV channels. This channel is received and converted to a signal for input to the secondary TV 2b. The remote control extender 40 converts IR signals from the remote 28 to signals which are transmitted in a frequency channel which is received and converted to control signals for input to the receiver 3. A schematic diagram of a wireless extension system is shown in FIG. 5. A first wireless transceiver 50 is connected to the secondary RF output 22b of the receiver 3 and converts the output signals to a frequency band suitable for domestic wireless signals, such as 2.4 GHz. The signals are transmitted through an antenna 51, which may be directional to improve gain and reduce interference with other devices. The signals are received by a second wireless transceiver 52 having an antenna 53, which is preferably directional to improve gain, where the signals are converted to UHF signals for input to the secondary TV 2b. The remote control extender 40 is similar to that shown in FIG. 4, except that the control signals are output as baseband signals on a cable connected to the second wireless transceiver 52, where they are modulated, up-converted and transmitted to the first wireless transceiver 51. The control signals are input to the secondary RF interface 22b, in a similar fashion to the wired extension system.

### Automatic Format Selection

From the above discussion, it is apparent that control signals received directly from the remote 28 by the receiver 3 are input at the IR receiver 29, while control signals received via an extender are input at the secondary RF interface 22b. In this embodiment, the receiver sets the picture format mode automatically according to the input at which the control signals are received. If the control signals are input at the IR receiver 29, this indicates that the user is at the primary location 42a and wants to watch the primary TV 2a. Therefore, a picture format mode suitable for the primary TV 2a is selected. If control signals are input at the secondary RF interface 22b, this indicates that the user is at the secondary location 42b and wants to watch the secondary TV 2b. Therefore, a picture format mode suitable for the secondary TV 2b is selected. The receiver 3 stores primary and secondary picture format modes suitable for the primary TV 2a and the secondary TV 2b respectively. These stored modes may be set and modified by the user or by an installation engineer.

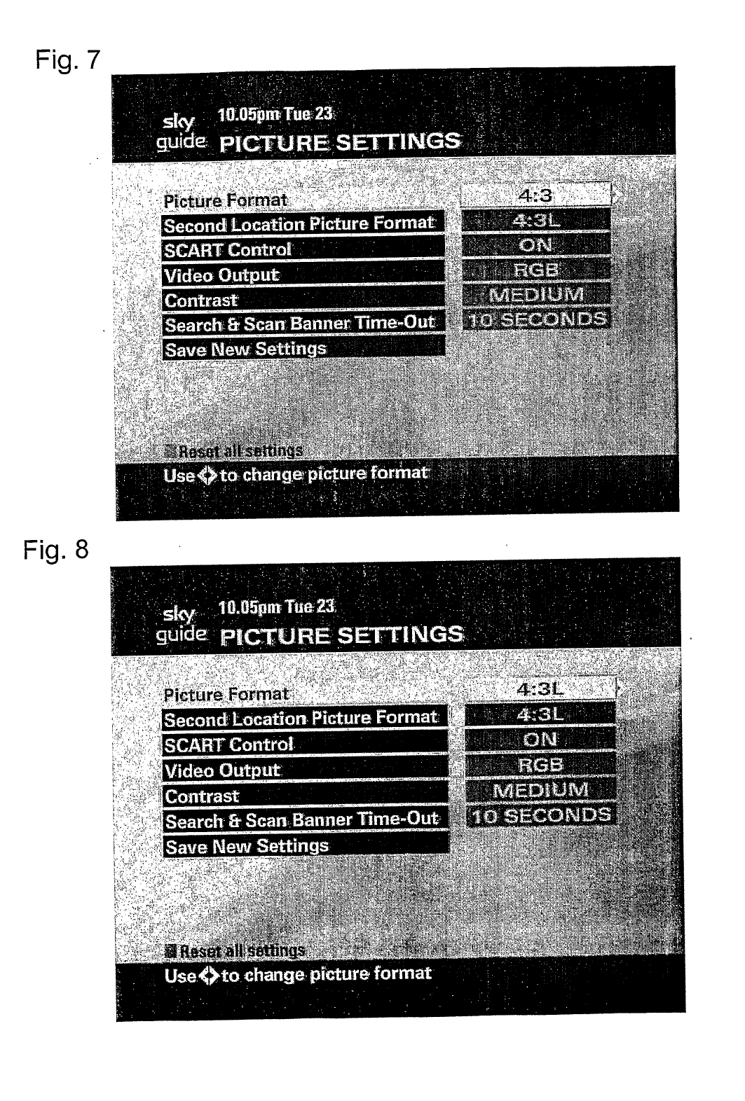

As described above, the receiver 3 stores and executes software which controls the operation of the receiver 3, including setting the picture format mode. In the first embodiment, the software includes a computer program for performing a method illustrated by the flowchart in FIG. 6. At step S1, the program receives a decoded control signal. At step S2, the program identifies on which input the control signal was received. If on the IR receiver 29, the program retrieves stored data indicating which format is set as the primary format, and controls the receiver 3 to output video signals in this format (step S3). If on the secondary RF interface 22b, the program retrieves stored data indicating which format is set as the secondary format, and controls the receiver 3 to output video signals in this format (step S4).

The computer program may be stored on a carrier and loaded into memory, such as the flash memory 27, on the receiver 3. The program may be downloaded as a satellite broadcast signal and applied as a patch or update to software already resident on the receiver 3. The scope of the present invention includes the program, the carrier carrying the program and the broadcast signal.

The decoded control signal may include an indication of which input received the control signal, or the program may perform an operating system call to detect whether the IR receiver 29 and/or the input at the secondary RF interface 22b is active. If both inputs are active, or a control signal was received from the other input within a predetermined short time, such as 30 seconds, this may indicate that different users are trying to watch the primary TV 2a and the secondary TV 2b simultaneously. In this case, the program may maintain the format currently set.

### Autoview

An additional problem occurs when the receiver 3 is set to tune to a channel automatically at a predetermined time. For example, a user may select from the EPG a programme to be viewed at a later time, and may select an ‘autoview’ option for that programme. The receiver 3 obtains the corresponding channel and time information for the selected programme, and automatically tunes to the channel at the start time of the programme. In this case, the receiver 3 has no information to indicate whether the user wants to watch the programme on the primary TV 2a or the secondary TV 2b. The receiver 3 therefore selects the primary format when displaying an Autoview programme, and prevents a change to the secondary format while the programme is shown, in case the programme is being recorded on the external video recorder 5 The primary format is maintained after the Autoview programme has finished, but may subsequently be changed in response to a control signal received on the secondary RF interface 22b. In other words, the program described with reference to FIG. 6 is disabled during an Autoview programme, and enabled thereafter.

The receiver 3 may display a reminder shortly before tuning to a channel in Autoview mode. The reminder can be removed by pressing a button on the remote 28. The format is not changed in response to the control signal cancelling the reminder display.

### Picture Format Settings

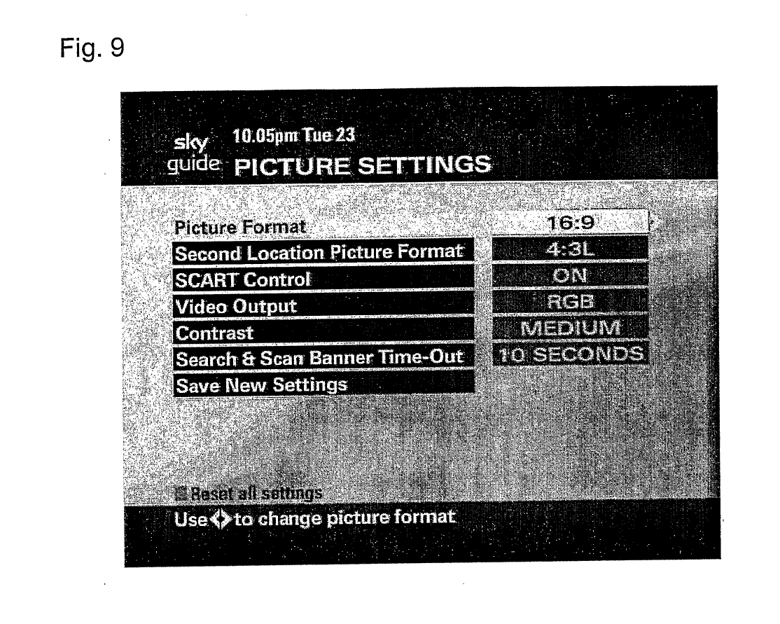

The method of setting the primary and secondary location settings will now be illustrated with reference to the screenshots shown in FIGS. 7 to 9. These show a modification of the picture settings menu provided on the Sky® Digibox® and Sky⁺® set top boxes. The picture settings menu includes a ‘picture format’ entry which corresponds to the primary format. When this entry is highlighted, as shown in FIGS. 7 to 9, the primary format can be selected between 4:3 (FIG. 7), 4:3 letterbox (FIG. 8) and 16:9 (FIG. 9), by pressing the left or right arrow button on the remote 28. The picture settings menu also includes a ‘Second Location Picture Format’ entry which corresponds to the secondary format. This entry can be highlighted by pressing a down arrow button on the remote 28 from any of the screens shown in FIGS. 7 to 9. The secondary format can then be changed between 4:3, 4:3 letterbox and 16:9, in the same way as the primary format.

### ALTERNATIVES TO THE FIRST EMBODIMENT

The effect of either type of extension system is that a user can control the same receiver 3 when viewing either the primary TV 2a or the secondary TV 2b. The location of the receiver 3 is only important because it contains the IR receiver 29. The receiver 3 may be at a third location if some means is provided for conveying control signals to that location. For example, an infrared repeater could be used to receive IR signals from the remote 28 at the first location 42a, convert the signals to electrical signals in a cable leading to the third location, and reconstruct the IR signals for emission to the IR receiver 29.

The first embodiment relates to automatically selecting the aspect ratio of the picture format output by the receiver 3, but alternatives to this embodiment may also fall within the scope of the present invention. A similar technique could be used to change other video settings which differ between a primary and a secondary display. For example, one or both of the displays may be a digital display having a native resolution. If the receiver 3 were to include a digital video output, it would be desirable to set the digital video signal to match the native resolution of the digital display. The picture format setting which is automatically selected in the first embodiment could then be a resolution setting instead of an aspect ratio.

A similar technique could also be used automatically to select audio settings, where common settings are applied to primary and secondary audio outputs, but different settings are desirable for audio reproduction apparatus connected to the primary and the secondary audio outputs.

Although the first embodiment is advantageously applied to a television receiver, it could also be applied to other sources of video and/or audio signals which is not able to apply settings independently to outputs to multiple devices. In particular, the first embodiment can be applied to live TV broadcasts, buffered live TV broadcasts where the displayed broadcast is buffered and delayed relative to the received broadcast, and to pre-recorded programmes, such as those previously recorded on the hard disk 13. Hence, the first embodiment could also be applied to a device which plays pre-recorded programmes but does not receive broadcasts, such as a video or DVD player.

### SECOND EMBODIMENT

### Wireless Audio System

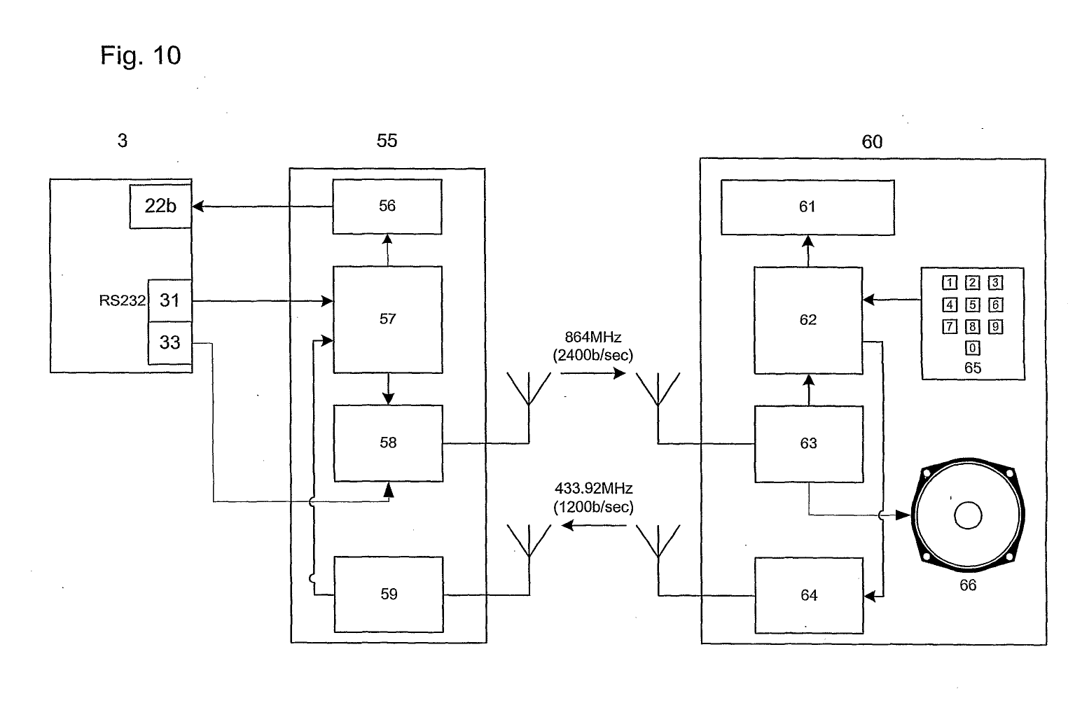

A second embodiment of the invention addresses the problem of listening to radio stations received by a television broadcast receiver. An arrangement of the receiver 3 in this embodiment is shown in FIG. 10. The receiver 3 is as described with reference to FIGS. 1 and 2.

A wireless audio base station 55 is connected to the stereo audio output 33 of the receiver and transmits a wireless audio signal to a wireless audio receiver 60 which plays the audio signal. A user can change channel using a keypad 65 to generate control signals. The control signals are transmitted back to the base station 55 and control the receiver 3 to retune to a different channel.

The receiver 3 outputs on the audio output 33 the audio content of the channel to which the receiver is tuned; the channel may be a television channel or a radio channel. Hence, the wireless audio receiver 60 can be used to listen to a television channel, but not to view the video content. The receiver 3 may also output audio signals, such as background music, in an interactive mode where no broadcast event is tuned to. Any audio signals output by the receiver 3 are relayed to the wireless audio receiver 60.

EPG data is output to the base station 55 by the receiver 3 and is transmitted to the audio receiver 60, where it is displayed on a liquid crystal display (LCD) 61. The user can change the EPG data and select programmes for listening using the keypad 65. This allows the user to receive radio stations wirelessly from the receiver, and to view EPG text information and messages, without requiring a video display.

The base station 55 includes a processor 57 which performs control and data processing functions. The processor 57 receives EPG data from the RS232 interface 31 of the receiver, and outputs the data to a modulator 58. The modulator 58 also receives audio signals from the audio output 33 which are FM converted and transmitted together with the data via an antenna.

The audio receiver 60 includes a demodulator 63, which receives the FM signal via an antenna and outputs the audio signal a loudspeaker 66. If the audio signal is a stereo signal, the left and right channels are output to separate loudspeakers 66a, 66b. The EPG data is decoded from the received signal and output to a processor 62, which controls the LCD 61 to display the EPG data as text.

The processor 62 receives and decodes control signals initiated by key presses on the keypad 65. In response to some control signals, the processor may vary the EPG data display. Other control signals are output to a modulator 64, where they are modulated and upconverted to a modulated control signal which is transmitted via an antenna.

The modulated control signal is received, down-converted and demodulated by a demodulator 59 in the base station 55. The demodulated control signals are processed by the processor 57 and output to a control interface 56, where they are input to the second RF interface 22b of the receiver 3.

In one example, the signal transmitted by the base station is at 864 MHz and carries the EPG data at a data rate of 2.4 kbit/s, as well as the audio FM signal. The control signal transmitted by the wireless audio receiver 60 is at 433.92 MHz and has a data rate of 1.2 kbit/s.

### Wireless Audio System Interfaces

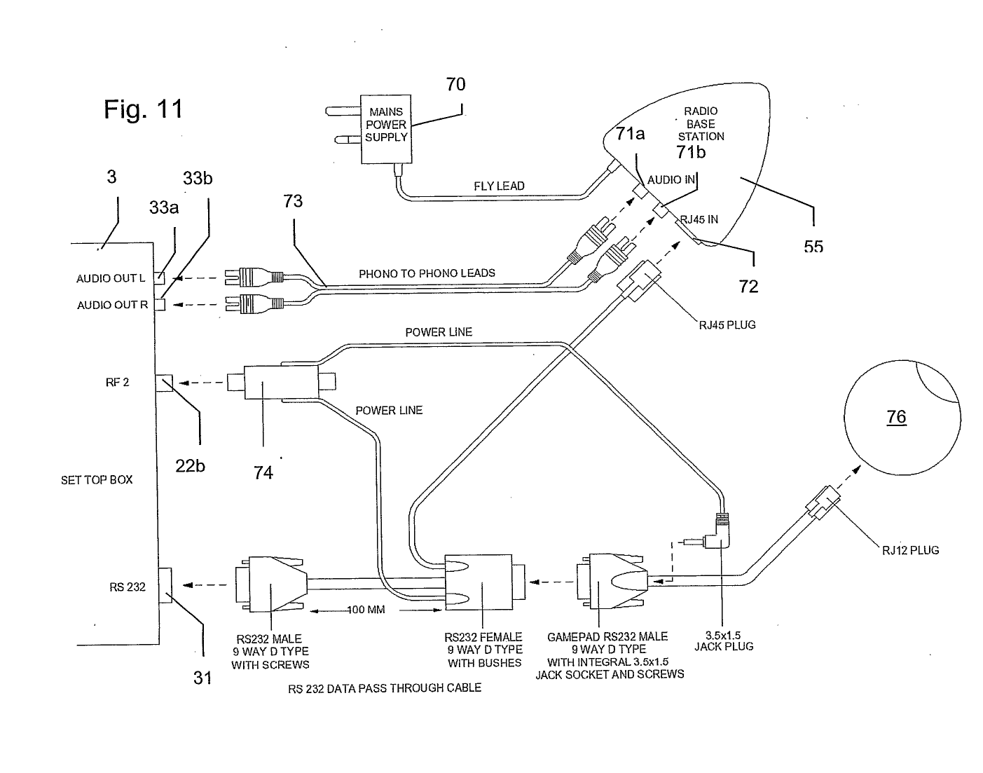

The input and output connections between the receiver 3 and the wireless audio base station 55 are shown in FIG. 11. The left and right channel audio outputs 33a, 33b are connected to corresponding left and right audio inputs 71a, 71b on the wireless audio base station 55 using phono-to-phone leads 73. The second RF interface 22b is connected via a link adapter 74 to a data interface 72 of the base station 55. The data interface 72 is also connected via the link adapter 74 to the RS232 interface 31 The link adapter 74 also allows an IR receiver 76 to be piggybacked onto the RS232 interface 32. The IR receiver 76 may receive signals from an additional control device, such as a game controller.

### Wireless Audio Receiver

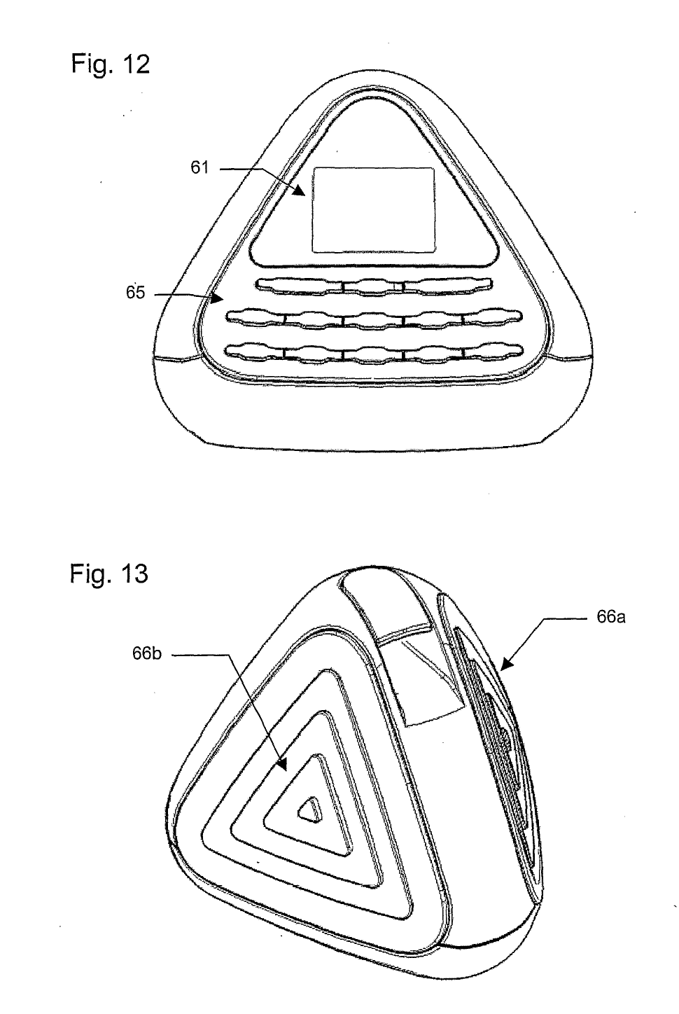

FIGS. 12 and 13 show one example of the appearance of the audio receiver 60, which is tetrahedral with rounded corners. FIG. 12 shows a front view of the audio receiver. The front face carries the LCD 61 and the keypad 65. The keys of the key pad include volume up and down, channel up and down, numeric keys and an on/off key.

FIG. 13 shows a perspective view from above, showing stereo loudspeakers 66a and 66b each on one rear face. The length of each side of the tetrahedron is approximately 15 cm, and weighs less than 1 kg, so that the audio receiver 60 is conveniently portable.

The audio receiver includes an internal battery (not shown), for portability. The battery is preferably rechargeable. Instead of, or in addition to the keypad 65, there may be provided an infrared remote control which sends control signals to an infrared receiver on the audio receiver 60.

### Electronic Programme Guide

As mentioned above with reference to FIG. 1, the receiver 3 presents programme schedule data in an Electronic Programme Guide (EPG). The EPG may be displayed in a text box overlaid on a video picture of the programme currently tuned to, or may replace the video picture. In either case, the data for display in the EPG is selected by the receiver 3 from broadcast data and converted to a video signal for output to the display 2. An example of an EPG is described in WO 96/37996.

In the second embodiment, EPG data from the receiver 3 is transmitted from the base station 55 to the audio receiver 60 using a text-based message protocol. No video data is included in the EPG data. In other words, the EPG text is encoded using a character code, rather than as an image. One advantage of using a character code is that the data rate requirement for the wireless link between the base station 55 and the audio receiver 60 is low. Another advantage is that the audio receiver can display the EPG data using a simple text display, such as the LCD 61. This display can be light, with a low power consumption, and therefore aids the portability of the audio receiver.

The character code may encode alphanumeric characters and graphic symbols. The code is converted by the processor 62 and/or the LCD 61 to a bitmap representing the corresponding characters or symbols. However, the character code itself does not define the bitmap which will be displayed, in contrast to a video signal or an image signal, which defines the state of each pixel to be displayed.

The display may show the channel number, channel name, and the event name, and optionally further information on the event. When the user changes channel, details of the new channel and new current event are displayed. The channel may be changed by pressing the channel up or channel down key, or by entering a three digit channel identity number using the numeric keys on the keypad 65. Each digit is transmitted to the receiver 3 as it is entered, and the receiver 3 echoes the digit back to the audio receiver 60 using the message protocol. When all three digits have been entered, the receiver 3 tunes to the corresponding channel and outputs the channel number, channel name, and the event name for that channel.

### EPG Message Protocol

In a specific example, the message protocol consists entirely of ASCII (American Standard Code for Information Interchange) characters formatted as variable length message using the format shown in Table 1 below:

TABLE 1
EPG Message Protocol

| Syntax | No. Bytes | Format | Comments |
|---|---|---|---|
| Start_Byte | 1 | ‘\n’ | Carriage return |
| Message_Length | 3 | Characters from | |
| | | ‘000’ to ‘999’ | |
| Message_Tag_Main | 2 | Characters | |
| Message_Tag_Sub | 2 | Characters | |
| Field_Length | 3 | Characters from | |
| | | ‘000’ to ‘999’ | |
| Field_Data | N | Characters | |
| Checksum | 2 | Hex Value in | Sum |
| | | Character Format | |

Each message begins with Start_Byte and Message_Length, and contains a variable number of fields, each prefaced with Message_Tag_Main, Message_Tag_Sub and Field_Length and containing Field_Data. Checksum is a checksum of the whole message. The message tag indicates what type of EPG data is contained in the message field, while Message_Tag_Sub has a definition which is dependent on the corresponding Message_Tag_Main. The audio receiver 60 decodes the EPG messages and displays the data content in a manner dependent on the message tag.

The software resident on the receiver 3 outputs EPG data on the RS232 interface 31 selectively, either in response to control signals received from the base station 55 via the second RF interface 22a, or automatically to output information indicating the status of the receiver 3 and/or the current time. To maximize the response time of the system, the receiver 3 may initially output only the most important information, such as the channel name, wait for any further control signals, and then output the event name.

The receiver 3 also generates and outputs the message tags, which are passed by the base station 55 to the audio receiver 60. The receiver 3 does not output all of the available EPG data, but only the EPG data which may be required for display on the audio receiver 60. However, the base station 55 may filter messages according to their message tags. For example, the receiver 3 may output a message indicating the current date and time, which is suppressed by the base station 55 in a mode in which time and date are not displayed on the audio receiver 60.

### ALTERNATIVES TO THE SECOND EMBODIMENT

Alternatives to the second embodiment may nevertheless fall within the scope of the present invention. For example, some or all of the functionality of the base station 55 could be integrated within the receiver 3.

Although the second embodiment is advantageously applied to a television receiver, it could also be applied to an audio-only receiver or an audio storage or reproduction device, such as a compact disc (CD) player.

The receiver 3 may receive the audio signal and/or EPG data from any suitable television or audio broadcast, whether via a satellite, terrestrial or cable broadcast or a media stream over a network, such as the Internet. The EPG data may be obtained from another source than the audio signal. For example, the EPG data could be downloaded from a network address, such as an Internet address.

1. A media device having at least first and second media outputs and respective associated first and second control inputs, the media device being arranged to select or modify media signals for output on the first and/or second media outputs in response to control signals received on either of the first and second control inputs; the device being further arranged to apply a common setting to the media signals output on the first and second media outputs; wherein the device is arranged to adopt a predetermined first or second setting as said common setting according to whether control signals are received respectively on said first or said second inputs.

2. A device according to claim 1, wherein said first and/or second settings are modifiable by a user.

3. A device according to claim 2, wherein the first and second settings are modifiable by the control signals input at the first and/or second control inputs.

4. A device according to claim 1, wherein the media signals include video signals.

5. A device according to claim 4, wherein the common setting comprises a picture format of the video signals.

6. A device according to claim 5, wherein the picture format comprises an aspect ratio.

7. A device according to claim 1, wherein the media signals include audio signals.

8. Apparatus including a device according to claim 1, a media relay for conveying the media signals from the second media output to a media player at a location remote from the device, and a control relay for relaying the control signals from the remote location to the device.

9. Apparatus according to claim 8, wherein the control relay is arranged to receive said control signals from a line-of-sight remote controller.

10. Apparatus according to claim 9, wherein the media device is arranged to receive the control signals at the first control input from said line-of-sight remote controller.

11. Apparatus according to claim 9, wherein the line-of-sight remote controller is an infra-red remote control.

12. A media system including apparatus according to claim 8, a first media player at a first location, means for conveying to the first control input said control signals initiated by a user from the first location, a second media player at a second location, and means for conveying to the second control input said control signals initiated by the user from the second location.

13. A television broadcast receiver arranged to output on primary and secondary outputs a video signal having a picture format common to said primary and secondary video outputs, and having an infrared receiver for receiving control signals from a remote control, and an auxiliary control input for receiving control signals from the remote control via a remote control extender, the receiver being arranged to detect whether a control signal is received by the infrared receiver or at the auxiliary control input, and to apply selectively a first or a second said picture format to said video signal, dependent on said detection.

14. A receiver according to claim 13, wherein the picture format comprises an aspect ratio.

15. A receiver according to claim 13, wherein the first and second picture formats are selectable by a user.

16. A method of setting a media output format for a media device having at least first and second media outputs and respective associated first and second control inputs, the media device being arranged to select or modify media signals for output on the first and/or second media outputs in response to control signals received on either of the first and second control inputs; the device being further arranged to apply a common setting to the media signals output on the first and second media outputs; the method comprising detecting whether the control signals are received on said first or said second inputs, and adopting respectively a predetermined first or second setting as said common setting in response to said detecting step.

17. A method according to claim 16, including modifying said first and/or second settings in response to user input.

18. A method according to claim 16, wherein the media signals include video signals.

19. A method according to claim 18, wherein the common setting comprises a picture format of the video signals.

20. A method according to claim 19, wherein the picture format comprises an aspect ratio.

21. A method according to claim 16, wherein the media signals include audio signals.

22. A computer program including program steps for performing a method according to claim 16 when executed by the media device.

23. A computer program product comprising the computer program of claim 22 recorded on a carrier.

24. A broadcast signal including a computer program according to claim 22.

25. A method substantially as herein described with reference to FIG. 6 of the accompanying drawings.

26. A wireless audio base station for receiving audio signals and programme schedule data, and for relaying the audio signals and the schedule data over a local wireless link to a wireless audio receiver, wherein the schedule data is encoded for transmission over the wireless link using a code which does not represent an image.

27. A base station according to claim 26, including a control signal receiver for receiving user control signals over the wireless link from the audio receiver.

28. A base station according to claim 27, responsive to the user control signals to vary a received broadcast channel containing said audio signals.

29. A base station according to claim 27, responsive to the user control signals to vary the schedule data transmitted over the wireless link.

30. A base station according to claim 27, wherein the control signal receiver is an RF receiver.

31. A base station according to claim 28, including a control signal output for outputting said control signals to a broadcast receiver.

32. A base station according to claim 31, including an audio input for receiving said audio signals from said broadcast receiver.

33. A base station according to claim 26, including an RF transmitter for transmitting over the wireless link.

34. A base station according to claim 26 wherein the schedule data transmitted over the wireless link includes information on a current programme comprising the received audio signals.

35. A base station according to claim 34, wherein the schedule data transmitted over the wireless link includes information on a different programme from the current programme.

36. A base station according to claim 26, wherein the code is a character code.

37. A base station according to claim 36, wherein the code includes tags identifying the type of data encoded in the character code.

38. A wireless audio receiver for receiving wireless audio signals and programme schedule data over a local wireless link from a wireless audio base station, and displaying the programme schedule data on a display, wherein the programme schedule data is encoded using a code which does not represent an image and the audio receiver is arranged to convert said code to an image on said display.

39. A receiver according to claim 38, including a control signal transmitter for transmitting user control signals over the wireless link to the audio base station.

40. A receiver according to claim 39, wherein said control signal transmitter is an RF transmitter.

41. A receiver according to claim 39, including a user-operable control for initiating said control signals.

42. A receiver according to claim 38, including an RF receiver for receiving said wireless audio signals and schedule data.

43. A receiver according to claim 38, wherein the code is a character code.

44. A receiver according to claim 43, wherein the code includes tags identifying the type of data encoded in the character code, the receiver being arranged to display the programme data on the display in dependence on said tags.

45. A broadcast receiver for receiving audio programmes and programme schedule data relating to the audio programmes and for retransmitting the audio programmes and the schedule data over a local wireless link, wherein the schedule data is retransmitted in a character-based format.

46. A wireless audio player for receiving audio programmes and programme schedule data relating to the programmes transmitted over a local wireless link from a broadcast receiver, wherein the schedule data is transmitted in a character-based format and displayed by the wireless audio player as characters on a display.
